(19) United States
(12) Patent Application Publication
(10) Pub. No.: US 2015/0278838 A1
(43) Pub. Date: Oct. 1, 2015

(54) SYSTEMS, METHODS, AND APPARATUSES FOR AGRICULTURAL DATA COLLECTION, ANALYSIS, AND MANAGEMENT VIA A MOBILE DEVICE

(71) Applicant: TekWear, LLC, Buford, GA (US)

(72) Inventors: Bruce Wayne RASA, Buford, GA (US); John David SWANSEY, Durham, NC (US); Erick Christian KOBRES, Lawrenceville, GA (US)

(21) Appl. No.: 14/676,534

(22) Filed: Apr. 1, 2015

Related U.S. Application Data
(60) Provisional application No. 61/973,547, filed on Apr. 1, 2014.

(51) Int. Cl. G06Q 30/02; G06F 17/30

(52) U.S. Cl. CPC G06Q 30/0205; G06F 17/3087; G06F 17/30041

(57) ABSTRACT

Systems and methods for data collection, management, and use, and more particularly to data collection, geolocation, and crop scouting using hands-free devices in agricultural interest zones. In various embodiments, users predefine criteria regarding a particular agricultural interest zone. Using geolocation techniques, in various embodiments, the system determines whether the user and a hands-free device are within an agricultural interest zone. According to various embodiments, within the agricultural interest zone, the user may collect data satisfying the predefined criteria and receive information from the system regarding the agricultural interest zone.

### CROSS REFERENCE TO RELATED APPLICATION

This application claims benefit under 35 U.S.C. §119(e) of and priority to U.S. Provisional Patent Application No. 61/973,547, filed Apr. 1, 2014, and entitled “Wearable Farmer Dashboard,” which is incorporated herein by reference as if set forth herein in its entirety.

### TECHNICAL FIELD

The present systems and methods relate generally to data collection, management, and use, and more particularly to data collection, geolocation, and crop scouting using hands-free devices in agricultural interest zones.

### BACKGROUND

Many farming and other agricultural operations are very complex and require a number of team members to perform tasks in different agricultural interest zones. The collection and processing of data regarding these agricultural interest zones is an unwieldy and sometimes dangerous process.

### BRIEF SUMMARY OF THE DISCLOSURE

Briefly described, and according to one embodiment, aspects of the present disclosure generally relate to systems, methods, and apparatuses for data collection, management, and use, and more particularly to data collection, geolocation, and crop scouting using hands-free devices in agricultural interest zones.

The disclosed embodiments facilitate the gathering and accessing of a wide variety of agrarian, agricultural, and other farming data based on geolocation. Generally, the term “agricultural” in the present disclosure relates to farming, harvesting, crops, crop-scouting, animal husbandry, veterinary activities, agrarian practices, maintaining farm machinery, and all other related activities as will occur to one of ordinary skill in the art. The gathered data may include, but is not limited to, crop scouting, animal health/surveillance, farm machinery and equipment statuses, grain management, irrigation system statuses, weather and market forecasting, etc. To address these and other needs, the embodiments of the present disclosure relate to methods, devices, systems and computer program products that take advantage of both audiovisual and sensory capability of hands-free devices to push information to and from the agricultural interest zone seamlessly. In these embodiments, live video and audio may be transmitted from the capture process, with transcription of the same by a human, an algorithm, or a combination of both. As a result, users may make sense of large amounts of information regarding their farms, may reduce the amount of paperwork, and may spend more time on high-value work activities in their agricultural interest zones with crops, machinery, and animals.

Generally, the disclosed embodiments accommodate novice users but are sophisticated enough to handle a broad range of necessary tasks. In one example embodiment, a program platform comprises a suite of application program software that is designed to allow users to utilize hands-free devices in a variety of farming operations. For example, the user may predefine criteria pertaining to a particular agricultural interest zone (e.g., data to be collected) and, once that user enters the agricultural interest zone, the hands-free device may manually or automatically collect data satisfying the predefined criteria.

In various embodiments, there are numerous benefits of using the disclosed system. The tools described herein may be more safely and more conveniently carried both in a particular agricultural interest zone and anywhere on a farm (e.g., field surveillance, animal surveillance, remote machinery monitoring, etc.). Also, the system may replace a number of items that previously needed to be carried into the field (such as large, bulky, physical and outdated identification guides). In various embodiments, the system also provides enhanced safety. For example, handling crops (e.g., cotton, corn, soybeans, or rice) sometimes requires two hands by one person to uproot, inspect, or hold a plant. Additionally, physical tools, such as a pocket knife and other agronomy-specific tools, are required to be used to perform a comprehensive assessment, write a prescription to remedy the issues, and improve the crop yield. With the hands-free devices, the user is able to safely use a pocket knife, or other physical tools.

According to one embodiment, the system includes an application that integrates with an existing, remote sensing online database. This database contains the outline of one or more agricultural interest zones in a particular geographic location and is further identified by the name of the owner of the agricultural interest zone (or some other identifier). Generally, in one embodiment, the agricultural interest zone may map to a common land unit (e.g., the smallest unit of land that has a permanent, contiguous boundary, a common land cover and land management, a common owner, and a common producer). A user may then walk into any agricultural interest zone and, once a “virtual fence” (e.g., geofence) is crossed, the hands-free device may greet the user in a personal way (e.g., announcing “Good morning, Mr. Fred Smith, welcome to Field #5, on the Smith Farm.”). Generally, any work activities the user chooses to take within that agricultural interest zone may be digitally tracked, stored, recorded (and optionally) shared with other users or trusted service providers. In various embodiments, all record keeping may be ‘passively’ collected and analyzed to assess and optimize the future productivity, environmental responsibility, and potential profitability of the whole-farm operation.

According to various embodiments, the volume of information within the system may grow significantly in both quantity and variety. Users may have difficulty handling this quantity of information; thus, in one embodiment, a software program, with an algorithm as the engine, may be used to distill and reduce this glut of info into a distilled solution that both the user and his/her set of trusted partners (e.g., agronomist, crop specialist, seed, chemical, machinery specialist, etc.) may use in a practical, everyday way to take action and improve the crop yield in an agricultural interest zone.

In various embodiments, patterns of insect swarms and plant diseases over large geographic areas may be collected by the disclosed system. This information may be used to alert users at increased risk of infestation and ultimately save crops. For example, a crop alert hazard may be received by a user stating “corn rootworm reported 5.4 miles from your location.”

Another embodiment is in the area of animal health/surveillance such as poultry production. A challenge to workers in this field is that they are in work environments (whether in a production building where chickens are raised or in a slaughtering facility) where they need to use one, or both, of their hands for worker safety. They are handling animals, yet still need to communicate or record the results of their observations. For example, a poultry inspector may need to touch both animals, as well as equipment in the facility/building, which would then be contaminated. The disclosed system enables a hands-free solution that allows the worker to capture and share, as well as receive, time-sensitive information that is required for them to perform their task efficiently.

In one embodiment, a method comprising the steps of: retrieving one or more predefined criteria corresponding to data management associated with a particular agricultural interest zone; transmitting the retrieved one or more predefined criteria for the particular agricultural interest zone to a particular hands-free device being operated by a user in the particular agricultural interest zone; receiving one or more data items from the particular hands-free device, wherein the one or more data items were automatically collected at the particular agricultural interest zone by the particular hands-free device; normalizing the one or more data items into a predetermined standardized format; comparing the normalized one or more data items to the retrieved one or more predefined criteria to ensure compliance with the retrieved one or more predefined criteria; and upon determination of compliance with the retrieved one or more predefined criteria, associating the normalized one or more data items with the particular agricultural interest zone and storing the normalized one or more data items in a database for subsequent processing.

In one embodiment, a method comprising the steps of: receiving a location identifier, corresponding to a particular physical location, from a particular hands-free device; determining whether the particular physical location is within one or more predefined geofences, corresponding to one or more agricultural interest zones; and upon determination that the particular physical location is within one or more predefined geofences, retrieving one or more predefined criteria corresponding to data management associated with the one or more predefined geofences; and transmitting the retrieved one or more predefined criteria for the one or more predefined geofences to the particular hands-free device for subsequent data management purposes.

In one embodiment, a method comprising the steps of: determining a particular location identifier, corresponding to the particular physical location of a hands-free device; transmitting the particular location identifier to a server; receiving one or more predefined criteria, corresponding to data management associated with the particular location identifier, from the server; determining, from the received on or more predefined criteria, one or more data items to collect from the particular physical location and the manner of collection for each of the one or more data items; collecting the determined one or more data items from the particular physical location through the determined manner of collection; and transmitting the collected one or more data items to the server for subsequent processing.

According to one aspect of the present disclosure, the method, wherein normalizing the one or more data items into a predetermined standardized format further comprises the steps of: identifying a received format of a particular data item; retrieving the predetermined standardized format for a particular data item type corresponding to the particular data item from the retrieved one or more predefined criteria; and converting the particular data item from the received format to the predetermined standardized format. Moreover, the method, wherein comparing the normalized one or more data items to the retrieved one or more predefined criteria to ensure compliance with the retrieved one or more predefined criteria further comprises the steps of: identifying an expected range of a particular normalized data items from the retrieved one or more predefined criteria; and confirming that the particular normalized data item is within the expected range. Further, the method, wherein comparing the normalized one or more data items to the retrieved one or more predefined criteria to ensure compliance with the retrieved one or more predefined criteria further comprises the steps of: identifying an expected range of a particular normalized data items from the retrieved one or more predefined criteria; confirming that the particular normalized data item is within the expected range; and upon determination that the particular normalized data item is not within the expected range, transmitting a request for re-collection of the particular normalized data item to the particular hands-free device; receiving a recollected data item from the particular hands-free device; normalizing the recollected data item into the predetermined standardized format for the particular data item; and determining whether the normalized recollected data item is within the expected range.

According to one aspect of the present disclosure, the method, wherein the particular hands-free device is selected from the group comprising a mobile phone, a tablet, a head-mounted device, a sensor-enabled eyewear, a sensor-enabled hat, or a sensor-enabled piece of farm equipment. Additionally, the method, wherein the piece of farm equipment is selected from the group comprising a tractor, a planter, a combine, a chemical application sprayer, or a baler.

According to one aspect of the present disclosure, the method, wherein the predefined criteria includes a request to gather one or more atmospheric data items. Also, the method, wherein the one or more atmospheric data items is selected from the group comprising ambient temperature, barometric pressure, humidity, and light exposure. Furthermore, the method, wherein the predefined criteria includes a request to gather one or more geographic data items. Moreover, the method, wherein the predefined criteria includes a request to gather one or more temporal data items. Further, the method, wherein the predefined criteria includes a request to gather one or more data items regarding one or more crops within the particular agricultural interest zone. Additionally, the method, wherein the predefined criteria includes a request to gather one or more data items regarding the particular agricultural interest zone. Also, the method, wherein the hands-free device comprises a device that receives voice data from the user in a hands-free manner and is configured to convert the voice data to text data. Furthermore, the method, wherein the hands-free device comprises a device that receives voice data from the user in a hands-free manner and is configured to respond to voice commands.

According to one aspect of the present disclosure, the method further comprising the steps of: receiving one or more data items from the particular hands-free device, wherein the one or more data items were automatically collected at the particular physical location by the particular hands-free device; normalizing the one or more data items into a predetermined standardized format; comparing the normalized one or more data items to the retrieved one or more predefined criteria to ensure compliance with the retrieved one or more predefined criteria; and upon determination of compliance with the retrieved one or more predefined criteria, associating the normalized one or more data items with the one or more predefined geofences and storing the normalized one or more data items in a database for subsequent processing. Moreover, the method, wherein normalizing the one or more data items into a predetermined standardized format further comprises the steps of: identifying a received format of a particular data item; retrieving the predetermined standardized format for a particular data item type corresponding to the particular data item from the retrieved one or more predefined criteria; and converting the particular data item from the received format to the predetermined standardized format.

According to one aspect of the present disclosure, the method, wherein comparing the normalized one or more data items to the retrieved one or more predefined criteria to ensure compliance with the retrieved one or more predefined criteria further comprises the steps of: identifying an expected range of a particular normalized data items from the retrieved one or more predefined criteria; and confirming that the particular normalized data item is within the expected range. Further, the method, wherein comparing the normalized one or more data items to the retrieved one or more predefined criteria to ensure compliance with the retrieved one or more predefined criteria further comprises the steps of: identifying an expected range of a particular normalized data items from the retrieved one or more predefined criteria; confirming that the particular normalized data item is within the expected range; and upon determination that the particular normalized data items is not within the expected range, transmitting a request for re-collection of the particular normalized data item to the particular hands-free device; receiving a recollected data item from the particular hands-free device; normalizing the recollected data item into the predetermined standardized format for the particular data item; and determining whether the normalized recollected data item is within the expected range. Additionally, the method, wherein the stored data items are associated with at least a first geofence and the subsequent processing further comprises the step of comparing all of the stored data items for the first geofence with each other to determine any trends occurring within the first geofence. Also, the method, wherein the stored data items are further associated with at least a second geofence and the subsequent processing further comprises the step of comparing all of the stored data items for the first geofence with all of the stored data items for the second geofence to determine any trends occurring within the first or second geofences and/or any trends occurring across the first and second geofences.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary overview of a deployed computer based agrarian data management system according to one embodiment of the present disclosure.

FIG. 2 illustrates an exemplary system architecture according to one embodiment of the present disclosure.

FIG. 3 illustrates an exemplary system architecture according to one embodiment of the present disclosure.

FIG. 4 illustrates an exemplary user interface of the agrarian data management system according to one embodiment of the present disclosure.

FIG. 5 illustrates the architecture of an exemplary device according to one embodiment of the present disclosure.

FIG. 6 illustrates an exemplary data collection and management process of the agrarian data management system according to one embodiment of the present disclosure.

FIG. 7 illustrates a geographic location sequence diagram of the agrarian data management system according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems, methods, and apparatuses for data collection, management, and use, and more particularly to data collection, geolocation, and crop scouting using hands-free devices in agricultural interest zones.

The disclosed embodiments facilitate the gathering and accessing of a wide variety of agrarian, agricultural, and other farming data based on geolocation. Generally, the term “agricultural” in the present disclosure relates to farming, harvesting, crops, crop-scouting, animal husbandry, veterinary activities, agrarian practices, maintaining farm machinery, and all other related activities as will occur to one of ordinary skill in the art. The gathered data may include, but is not limited to, crop scouting, animal health/surveillance, farm machinery and equipment statuses, grain management, irrigation system statuses, weather and market forecasting, etc. To address these and other needs, the embodiments of the present disclosure relate to methods, devices, systems and computer program products that take advantage of both audiovisual and sensory capability of hands-free devices to push information to and from the agricultural interest zone seamlessly. In these embodiments, live video and audio may be transmitted from the capture process, with transcription of the same by a human, an algorithm, or a combination of both. As a result, users may make sense of large amounts of information regarding their farms, may reduce the amount of paperwork, and may spend more time on high-value work activities in their agricultural interest zones with crops, machinery, and animals.

Generally, the disclosed embodiments accommodate novice users but are sophisticated enough to handle a broad range of necessary tasks. In one example embodiment, a program platform comprises a suite of application program software that is designed to allow users to utilize hands-free devices in a variety of farming operations. For example, the user may predefine criteria pertaining to a particular agricultural interest zone (e.g., data to be collected) and, once that user enters the agricultural interest zone, the hands-free device may manually or automatically collect data satisfying the predefined criteria.

In various embodiments, there are numerous benefits of using the disclosed system. The tools described herein may be more safely and more conveniently carried both in a particular agricultural interest zone and anywhere on a farm (e.g., field surveillance, animal surveillance, remote machinery monitoring, etc.). Also, the system may replace a number of items that previously needed to be carried into the field (such as large, bulky, physical and outdated identification guides). In various embodiments, the system also provides enhanced safety. For example, handling crops (e.g., cotton, corn, soybeans, or rice) sometimes requires two hands by one person to uproot, inspect, or hold a plant. Additionally, physical tools, such as a pocket knife and other agronomy-specific tools, are required to be used to perform a comprehensive assessment, write a prescription to remedy the issues, and improve the crop yield. With the hands-free devices, the user is able to safely use a pocket knife, or other physical tools.

According to one embodiment, the system includes an application that integrates with an existing, remote sensing online database. This database contains the outline of one or more agricultural interest zones in a particular geographic location and is further identified by the name of the owner of the agricultural interest zone (or some other identifier). Generally, in one embodiment, the agricultural interest zone may map to a common land unit (e.g., the smallest unit of land that has a permanent, contiguous boundary, a common land cover and land management, a common owner, and a common producer). A user may then walk into any agricultural interest zone and, once a “virtual fence” (e.g., geofence) is crossed, the hands-free device may greet the user in a personal way (e.g., announcing “Good morning, Mr. Fred Smith, welcome to Field #5, on the Smith Farm.”). Generally, any work activities the user chooses to take within that agricultural interest zone may be digitally tracked, stored, recorded (and optionally) shared with other users or trusted service providers. In various embodiments, all record keeping may be ‘passively’ collected and analyzed to assess and optimize the future productivity, environmental responsibility, and potential profitability of the whole-farm operation.

According to various embodiments, the volume of information within the system may grow significantly in both quantity and variety. Users may have difficulty handling this quantity of information; thus, in one embodiment, a software program, with an algorithm as the engine, may be used to distill and reduce this glut of info into a distilled solution that both the user and his/her set of trusted partners (e.g., agronomist, crop specialist, seed, chemical, machinery specialist, etc.) may use in a practical, everyday way to take action and improve the crop yield in an agricultural interest zone.

In various embodiments, patterns of insect swarms and plant diseases over large geographic areas may be collected by the disclosed system. This information may be used to alert users at increased risk of infestation and ultimately save crops. For example, a crop alert hazard may be received by a user stating “corn rootworm reported 5.4 miles from your location.”

In one embodiment, aspects of the present disclosure relate to decision support systems to decrease environmental impact and improve profitability of the monitored agricultural interest zones.

Another embodiment is in the area of animal health/surveillance such as poultry production. A challenge to workers in this field is that they are in work environments (whether in a production building where chickens are raised or in a slaughtering facility) where they need to use one, or both, of their hands for worker safety. They are handling animals, yet still need to communicate or record the results of their observations. For example, a poultry inspector may need to touch both animals, as well as equipment in the facility/building, which would then be contaminated. The disclosed system enables a hands-free solution that allows the worker to capture and share, as well as receive, time-sensitive information that is required for them to perform their task efficiently. To further understand the disclosed system a description of the figures may be useful.

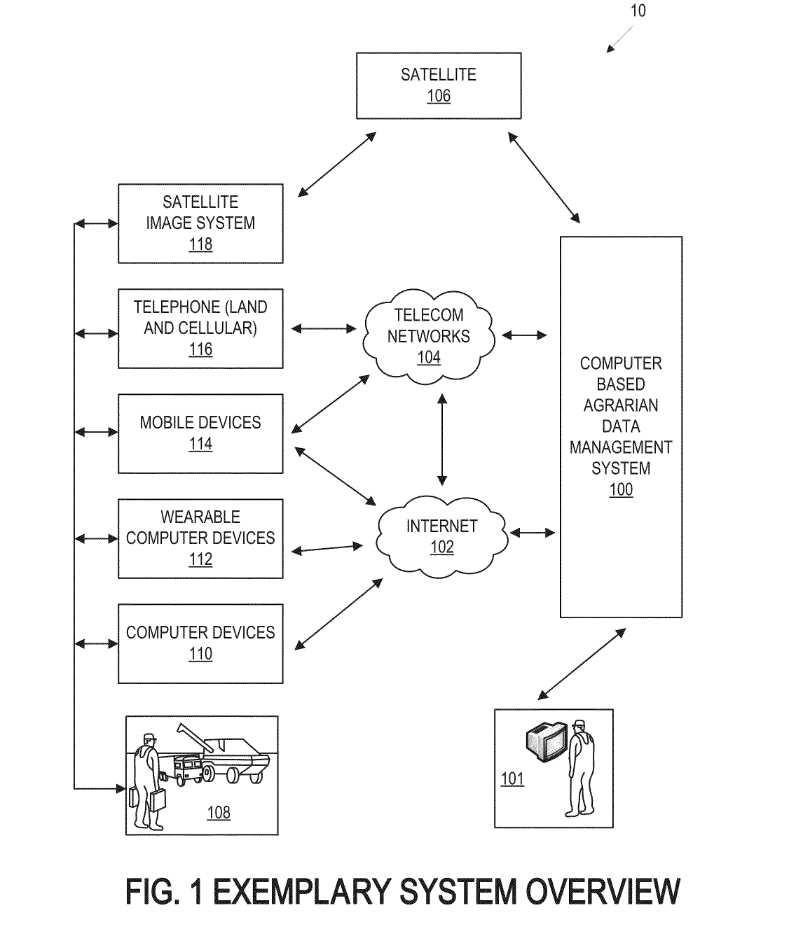

Referring now to the figures, FIG. 1 illustrates an exemplary overview 10 of a deployed computer based agrarian data management system 100, according to one embodiment of the present disclosure. In one embodiment, the computer based agrarian data management system 100 (alternatively referred to herein as the “agrarian data management system” or “system”) may be operatively connected to various hands-free devices via electronic communication interfaces. One skilled in the art will appreciate that the agrarian data management system 100 is not limited to the configuration in FIG. 1 but may include any combination of devices, networks, and/or other components necessary to carry out the functions of the agrarian data management system 100. According to one embodiment, a user 108 (e.g., a farmer, farmhand, etc.) may use one or more hands-free devices within an agricultural interest zone (e.g., a particular, bounded physical location, such as a particular field or area that contains a particular crop, collection of animals, farm equipment, etc.; a particular animal; a particular plant, tree, other crop, etc.; etc., that a user desires to monitor for any reason including, but not limited to, the collection and management of data, the tracking of performance over time, compliance reporting, etc. Generally, the term “agricultural yield zone” is used synonymously in this disclosure as “agricultural interest zone” or “AYZ” or “AIZ.”)

In various embodiments, the agrarian data management system 100 includes servers, databases, software programs, other computing components, etc. to perform its disclosed functions. The agrarian data management system 100, in various embodiments, may be operatively connected to hands-free devices (also referred to herein as “mobile devices”) via electronic communication interfaces, such as the internet 102, telecommunications networks 104 (e.g., land-based telephony systems, satellite, cellular telephony systems, etc.), satellite-based communication networks 106, etc. According to various embodiments, the hands-free devices may communicate with the agrarian data management system 100 through those same electronic communication interfaces. Generally, the agrarian data management system 100 and hands-free devices may communicate via any means that provide a reliable, real-time connection.

In various embodiments, hands-free devices include, but are not limited to, computer devices 110 (e.g., desktop and laptop computers), wearable computer devices 112 (e.g., head-mounted display devices, sensor-enabled hats, sensor-enabled eyewear like Google Glass®, smart watches, smart textiles, etc.), mobile devices 114 (e.g., smart phones, tablets, etc.), telephones 116, satellite image devices 118, location-based devices (e.g., GPS, ground-based transmitters like an RTK system, etc.), and sensor-enabled farm equipment (e.g., tractors, balers, combines, planters, harvesters, chemical application sprayers, etc.). According to the specific aspects shown in FIG. 1, computer devices 110, wearable computer devices 112, mobile devices 114, and telephones 116 are all non-limiting examples of hands-free or mobile devices. Generally, a hands-free device may be any device that is capable of recording multi-modal data (e.g., sensor data, audio, visual, etc.) in an agricultural interest zone without the need to be physically held by a user 108. In one embodiment, a hands-free device may only receive one type of data (e.g., only sensor, only audio, only text, only speech, etc.). A person having ordinary skill in the art will recognize that, in some embodiments, the input received by hands-free devices may be tactile input (e.g., mobile devices 114 can receive voice commands but can also receive input from a user's 108 hands, fingers, etc.).

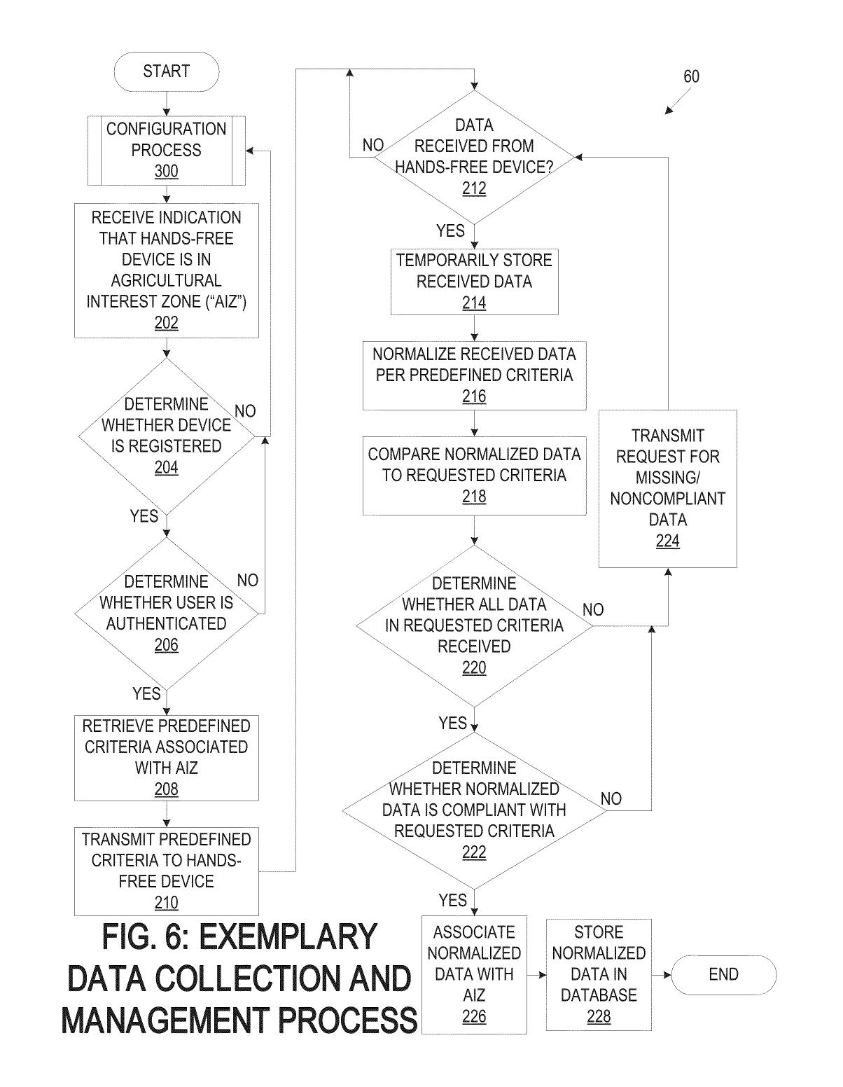

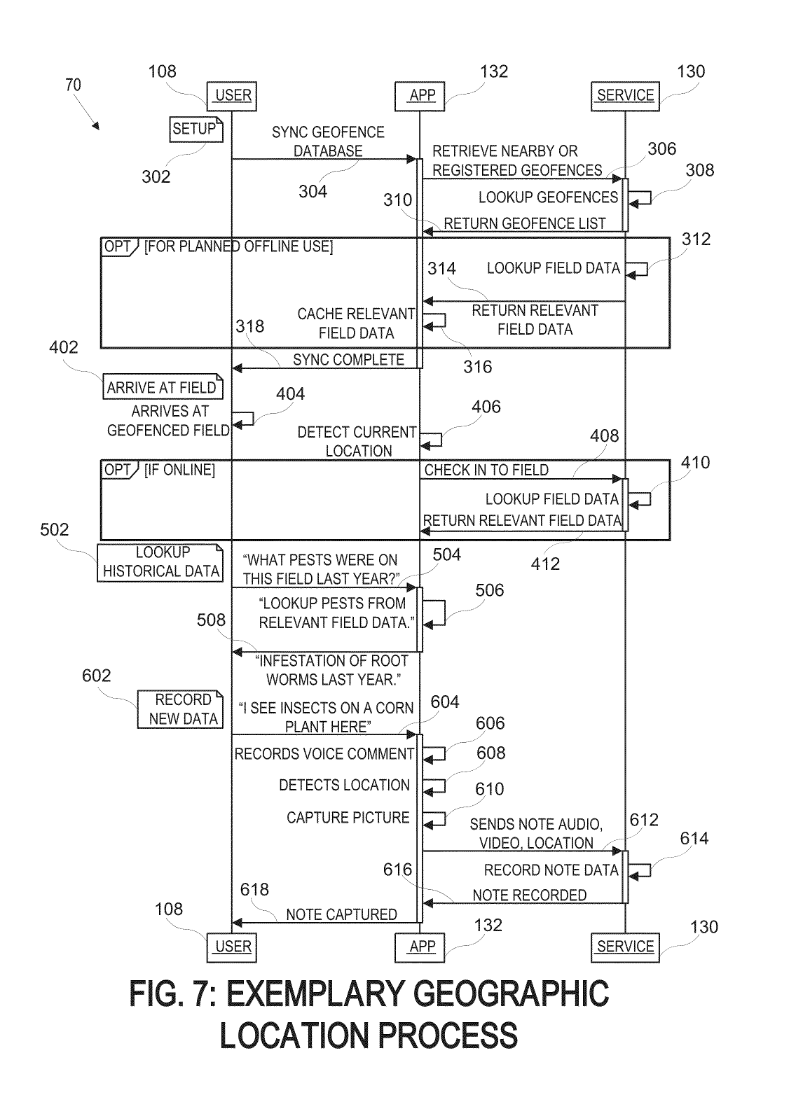

As will be appreciated by one having ordinary skill in the art, the hands-free devices provide a human interface for a user 108 to submit and receive information and to interface with the agrarian data management system 100. In various embodiments, the hands-free devices automatically record data regarding the agricultural interest zone, as will be further explained in connection with the description of FIG. 6. In one embodiment, the hands-free devices only record data when prompted by the user 108 (e.g., by pressing a button, saying a command, gesturing, etc.). In various embodiments, the hands-free devices may provide the user with information regarding the agricultural interest zone, as will be explained in connection with the description of FIG. 7.

Generally, in one embodiment, a user 108 is able to view all data collected via the hands free devices and agrarian data management system 100 in one central dashboard terminal 101. In various embodiments, the dashboard terminal 101 is any device capable of displaying the collected data (e.g., laptop and desktop computers, tablets, mobile phones, etc.). As will be appreciated by one having ordinary skill in the art, the dashboard terminal 101 allows a user 108 to monitor all data being recorded across agricultural interest zones, to share that data with other users, and to compare that data to historical records regarding those agricultural interest zones. In one embodiment, a user 108 may access the dashboard terminal 101 at a later date and/or different location than when and where the data was originally collected to view the collected data. To better understand the dashboard terminal 101 and the agrarian data management system 100, an explanation of the system architecture may be useful.

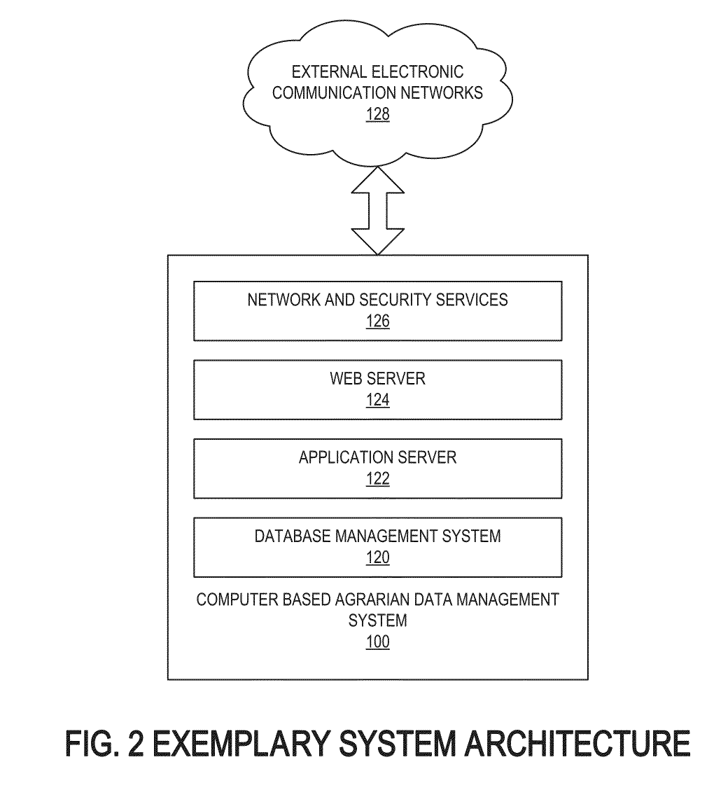

Now referring to FIG. 2, an exemplary agrarian data management system 100 architecture is shown according to one embodiment of the present disclosure. In various embodiments, the system 100 comprises a database management system 120, application server 122, web server 124, and network and security services 126.

According to one embodiment, the database management system 120 stores and associates data received from the hands-free devices and the user 108 regarding agricultural interest zones. As will be appreciated by one having ordinary skill in the art, the database management system 120 permits the user 108 to easily access information regarding a particular agricultural interest zone and to spot trends regarding specific crops, locations, pests, etc.

Still referring to FIG. 2, in one embodiment, the application server 122 may host unique computer-implemented services, such as data collection, data processing, data analysis, crop scouting, reporting, compliance, etc. For example, in various embodiments, the system 100 may communicate information to a user and also receive information from a user in a number of categories via services hosted on the application server 122. These categories may include, but are not limited to: crop scouting, machinery and equipment operational information, grain management, irrigation systems updates, precision farming, wireless technologies, GPS/Satellites, weather and market forecasting, etc. Each category may have multiple subcategories. For example, as will be further explained in connection with the description of FIG. 7, the crop scouting category may include various kinds of crops, such as cotton, wheat, soy beans, rice, etc.

In one embodiment, the web server 124 hosts web services which may include web page hosting and communicating with the application server 122 and/or the database management system 120. Generally, the system 100 may implement network and security services 126 to provide communication interface services with hands-free devices via the external communication networks 128 (e.g., internet 102, telecommunications networks 104, or satellite-based communication networks 106 from FIG. 1). To further understand the communication between the system 100 and the hands-free devices, an explanation of the hands-free device's architecture may be useful.

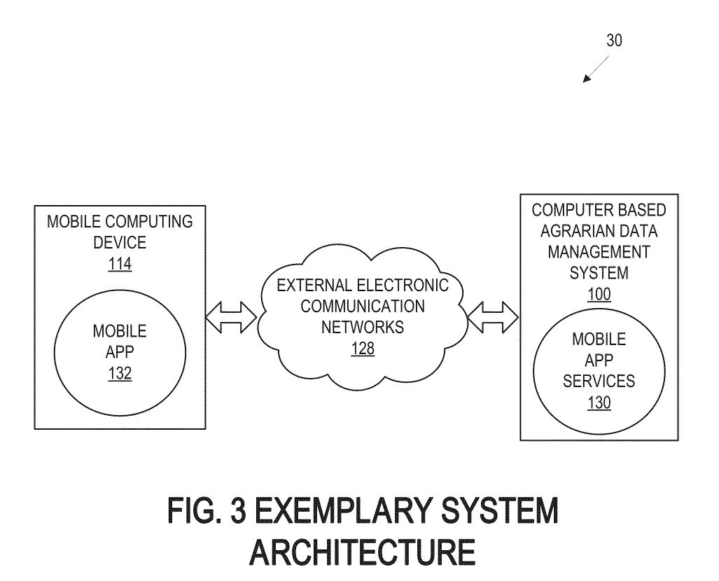

FIG. 3 illustrates the system architecture of an exemplary deployed agrarian data management system 100, according to one embodiment of the present disclosure. Generally, a mobile computing device 114 (e.g., hands-free device) runs one or more mobile applications 132 (e.g., for crop scouting, machinery and equipment operational information, grain management, irrigation systems updates, precision farming, wireless technologies, GPS/Satellites, weather and market forecasting, etc.). The functionality of the mobile applications 132 will be further explained in connection with the description of FIG. 7. In various embodiments, the mobile computing device 114 is operatively connected to the computer based agrarian data management system 100 via external communication networks 128. In one embodiment, the mobile application 132 provides computer-implemented methods for the users 108 to interact with the system 100.

In one embodiment, the system 100 hosts a mobile application service 130 on the application server 122. According to various embodiments, the mobile application service 130 communicates over an electronic communications network 128 with mobile applications 132 hosted on mobile computing devices 114 (e.g., hands-free devices). The functionality of the mobile application service 130 will be further explained in connection with the description of FIG. 7. According to one embodiment, services and devices integrated into existing hands-free devices (e.g., smart phones) enable electronic signature parameters such as latitude and longitude via built in GPS and/or built in location lookup capability, network derived time stamps, phone number, cellular tower metadata, cellular handset identifiers, network MAC address, network IP address, and built in biometric signatures to be delivered with an information report. To better understand how hands-free devices function within the system 100, a description of the system user interface may be useful.

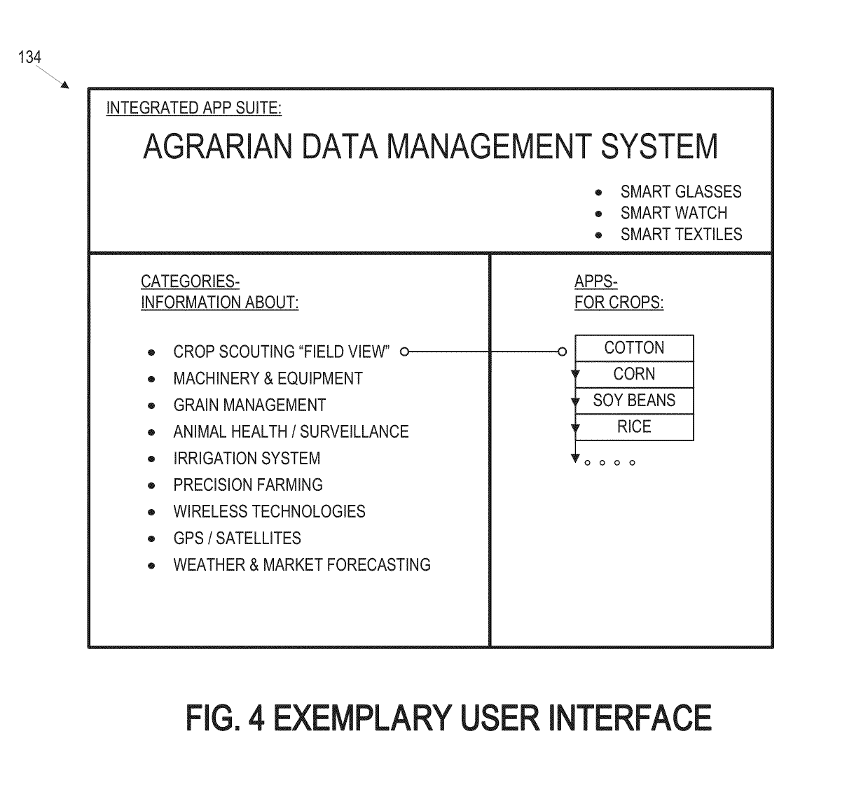

Referring now to FIG. 4, an exemplary user interface 134 of the agrarian data management system 100 according to one embodiment of the present disclosure is shown. Generally, the exemplary user interface 134 may be viewed on any hands-free device or the dashboard terminal 101 from FIG. 1. In various embodiments, the user interface 134 provides access to a suite of mobile applications, such as mobile application 132 shown in FIG. 3, for various tasks. According to one embodiment, these applications may synchronize and provide information to a user 108 in real-time through the day, as requested or configured by the user 108. In a particular embodiment, the information may be supplied via application programming interfaces (e.g., “APIs”) from multiple vendors, which may include, but are not limited to, machinery, seed, fertilizer, grain storage, chemical, and irrigation vendors. Generally, the ability to have a diversity of data inputs means that the system may be vendor agnostic, which is advantageous to users because the user does not have to be locked-in to the products and services of a single vendor. In a particular embodiment, the information may be user generated via hands-free devices or other inputs.

In various embodiments, the user interface 134 offers a unified experience for use of the system 100 and may be simple and practical to use. In one embodiment, the user interface 134 combines at least five elements: mobile, social media, data, sensors, and location-based services. Generally, these elements may work together in a synergistic fashion to deliver the highest, most relevant information to the task at hand in the agricultural interest zone. The integration of hands-free devices means, in various embodiments, that the user 108 has the freedom to work with both hands and simultaneously have hands-free communication. According to various embodiments, the system 100 enables real-time transfer of information to and from a field of crops (as will be further explained in the descriptions of FIGS. 6 and 7). In one embodiment, the system 100 provides remote expertise for unskilled labor so that they may conduct complicated tasks with little to no training. In a particular embodiment, the system 100 provides contextual computing, and a GPS chip in the wearable devices means that the user may be informed of their exact location and dynamic navigation maps may be delivered.

As will be appreciated by one having ordinary skill in the art, the user interface of the system 100 may not have any visual component but may instead rely on audio descriptions and inputs, tactile buttons and inputs, gestures, etc. Generally, the system 100 may have the same functionality regardless of the user interface, and the user interface may be adapted for the task that it enables for the hands-free device on which it operates.

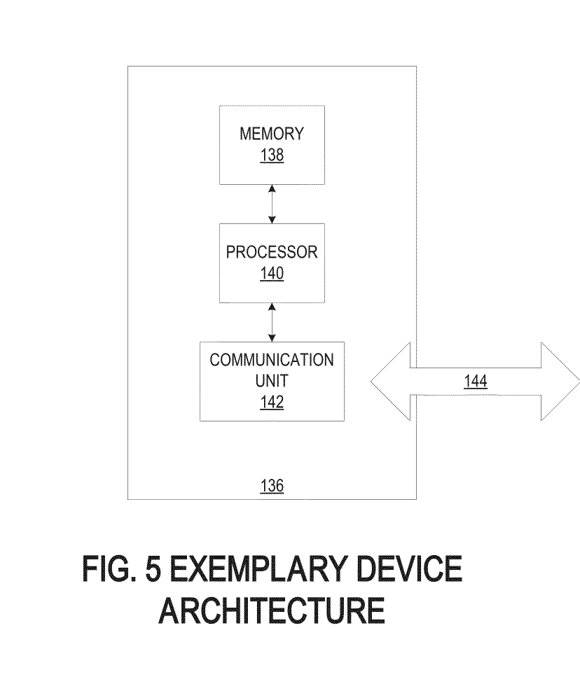

An understanding of the devices that run the system 100 may be useful to further explain the user interface 134. Generally, the functions accessed through the user interface 134 may be implemented using the system 100 described in FIGS. 1-7. In various embodiments, a device 136 as shown in FIG. 5 may be employed to implement these functions. According to one embodiment, the device 136, which is part of the agrarian data management system 100, comprises a memory unit 138, a processor 140, a communication unit 142 and a communication link 144. According to another embodiment, device 136 (e.g., hands-free device), comprises a memory unit 138, a processor 140, a communication unit 142 and a communication link 144. Generally, the device 136 runs data collection processes and geolocation processes of which further explanation may be useful.

Now referring to FIG. 6, an exemplary data collection and management process 60 of the agrarian data management system 100, according to one embodiment of the present disclosure, is shown. In various embodiments, some of the processes may run on the agrarian data management system 100 while others run on a hands-free device. In some embodiments, all of the processes may run on a hands-free device. As will be understood by one having ordinary skill in the art, the steps and processes shown in FIG. 6 (and those of all other flowcharts and sequence diagrams shown and described herein) may operate concurrently and continuously, are generally asynchronous and independent, and are not necessarily performed in the order shown.

In particular embodiments, the data collection process begins with the configuration process 300. Generally, the configuration process 300 comprises receiving designations of criteria (e.g., predefined criteria) that will dictate various rules relating to data capture preferences, reporting requirements, data templates, user information, agricultural interest zone information, etc. In one embodiment, a user 108, during the configuration process 300, may define agricultural interest zones and their corresponding geographical locations (e.g., geofencing as will be explained in connection with the description of FIG. 7), planted crops, past histories (e.g., prior pest infestations, plantings, pesticide/herbicide/fertilizer applications, etc.), etc. With this information, according to one embodiment, the configuration process 300 may determine the criteria and data to be gathered in an agricultural interest zone. In a particular embodiment, the user 108 may define the criteria and data to be gathered and used in an agricultural interest zone. According to various embodiments, the user 108 may designate the particular users and hands-free devices that may collect and access data within an agricultural interest zone.

Referring still to FIG. 6, at step 202, in a particular embodiment, the agrarian data management system 100 receives an indication (via internet 102, telecommunications networks 104, satellite-based communication networks 106, etc.) that a hands-free device is physically present in an agricultural interest zone. Generally, the methods of determining whether a device is in a particular agricultural interest zone will be better understood in connection with the description of FIG. 7. Continuing at step 204, in one embodiment, the system determines whether the hands-free device is registered for data collection within that particular agricultural interest zone. If the hands-free device is not registered for data collection within that particular agricultural interest zone, then, in one embodiment, the system returns to the configuration process 300. If the hands-free device is registered for data collection within that particular agricultural interest zone, then, according to one embodiment, the system determines, at step 206, whether the user 108 is authenticated to use that hands-free device and to collect data within that particular agricultural interest zone. If the user is not authenticated, in one embodiment, then the system returns to the configuration process 300.

If the user is authenticated, in a particular embodiment, then the system retrieves the predefined criteria associated with the agricultural interest zone at step 208. In one embodiment, the predefined criteria may be from the configuration process 300. The predefined criteria, generally, are rules and/or settings that define whether and which data to collect in a particular agricultural interest zone, which users and/or hands-free devices may collect that data, etc. In step 210, according to one embodiment, the system transmits the predefined criteria to the hands-free device. In one embodiment, the hands-free device may use the predefined criteria to determine whether and which data to collect in the agricultural interest zone. For example, the predefined criteria may indicate a list of several data items that may be collected from an agricultural interest zone (e.g., temperature, light exposure, etc.). In various embodiments, the system may automatically collect the data defined in the predefined criteria via the hands-free device. According to various embodiments, the system may prompt the user to manually collect the data defined in the predefined criteria via the hands-free device. In particular embodiments, the hands-free device transmits collected data to the system for processing and storage.

According to various embodiments, the system determines whether data has been received from the hands-free device at step 212. Generally, steps 212-228 may occur at a central server, backend server, device, etc. within the system. If the system has not yet received data from the hands-free device, then the system waits until the data has been received. Once the system determines that data has been received, then, in one embodiment, the system temporarily stores the data at step 214. As will be appreciated by one having ordinary skill in the art, the system may temporarily store the data in any suitable storage medium and format. According to various embodiments, at step 216, the system normalizes the data received from the hands-free device in accordance with the predefined criteria. For example, the system converts measurements into the proper units, processes videos and/or images to determine their content, converts audio files to text, etc. At step 218, in one embodiment, the system compares the normalized data to the criteria that was requested in the predefined criteria. As will be appreciated by one having ordinary skill in the art, normalizing the data and steps 220 and 222, may help the system ensure the accuracy of the data collection process.

Still referring to FIG. 6, at step 220, the system determines whether all of the criteria requested in the predefined criteria were received from the hands-free device. If some of the requested criteria are missing, then, in one embodiment, the system transmits a request for the missing data at step 224. If all of the requested criteria are present, then, in one embodiment, the system determines, at step 222, whether all of the normalized data is compliant with the requested criteria from the predefined criteria (e.g., all of the temperature data was within the expected ranges, etc.). If some of the data is not compliant with the requested criteria, then the system transmits a request for the noncompliant data at step 224. After transmitting the request for noncompliant and/or missing data at step 224, the system determines, in one embodiment, whether the requested data has been received at step 212.

If all of the data is compliant with the requested data, then, in one embodiment, the system associates the normalized data with the agricultural interest zone from which it was gathered at step 226. As will be appreciated by one having ordinary skill in the art, associating the normalized data with the agricultural interest zone permits the user 108 to access data for specific locations, compare historic information, etc. At step 228, in one embodiment, the system stores the normalized data in a database, and the data collection process ends thereafter. In one embodiment, step 228 may include transmitting the data to a central or backend server within the system 100. To further understand the data collection process, a description of the geographic location process may be useful.

Referring now to FIG. 7, a geographic location sequence diagram 70 of the agrarian data management system 100 is shown according to one embodiment of the present disclosure. Generally, the geographic location sequence diagram 70 depicts the geographic location setup process 302, geographic location determination process 402 (alternatively referred to herein as the “geolocation process”), and exemplary use cases 502 and 602, according to particular embodiments of the present disclosure. In various embodiments, the processes shown in FIG. 7 permit the system 100 to determine which agricultural interest zones a particular hands-free device is within and to collect and manage data associated with those agricultural interest zones.

In various embodiments, the geographic location setup process 302 begins when the user 108, at step 304, syncs a geofence database to a particular mobile application 132 on a hands-free device. In one embodiment, the geofence database contains the information for the geofences (e.g., virtual barriers that define the boundaries of a particular agricultural interest zone latitude/longitude coordinates or other location methodology) known by the agrarian data management system 100 that pertain to particular agricultural interest zones monitored by the agrarian data management system 100. Generally, the geofences may or may not relate to a specific agricultural interest zone and may be more discrete in size than a field (e.g., a specific animal, flock, herd, piece of equipment, particular pinpoint location either within or relating to an agricultural interest zone, etc.). At step 306, in various embodiments, the application 132 requests, from the application service 130, a list of the geofences that are proximate to the user's location or registered in the system 100. The application service 130, in one embodiment, at step 308, retrieves the list of geofences and transmits that list to the application 132 at step 310. At step 312, according to one embodiment, the application service 130 may retrieve data pertaining to a particular agricultural interest zone and transmit that data to the application 132, at step 314. According to one embodiment, if the application anticipates operating in an offline mode (e.g., not connected to the application service 130 via a communications network 128), then at step 316, the application 132 may cache the data received at step 314. At step 318, once syncing the geofence database to the particular application 132 is complete, the setup process 302 ends. After setup, the user 108 is now ready to begin the geographic location determination process 402.

The geographic location determination process 402, in various embodiments, begins when the user enters a geofenced agricultural interest zone at step 404. At step 406, in one embodiment, the application 132 determines the current location of the user 108 (e.g., via GPS, RTK, etc.). According to one embodiment, at step 408, the application 132 transmits to the application service 130 that it has arrived within the agricultural interest zone. At step 410, in a particular embodiment, the application service 410 retrieves the data relevant to the agricultural interest zone (e.g., the predefined criteria from FIG. 6) and transmits the data, at step 412, to the application 132. In various embodiments, the geographic location determination process 402 ends thereafter. As will be appreciated by one having ordinary skill in the art, in various embodiments, the geographic location determination process 402 may occur before, during, or after the geographic location setup process 302.

Still referring to FIG. 7, once the user 108 is within a particular agricultural interest zone, in various embodiments, the user 108 may take various actions regarding the agricultural interest zone (e.g., retrieve data regarding the agricultural interest zone via the lookup process 502, record new data regarding the agricultural interest zone via the recording process 602, etc.). As will be appreciated by one having ordinary skill in the art, the lookup process 502 and recording process 602 may be repeated as many times as desired by the user 108 within a particular agricultural interest zone. Further, the particular steps in FIG. 7 for the lookup process 502 and recording process 602 are not required parts of the sequence but are instead exemplary steps of the processes, according to one embodiment.

In one embodiment, the lookup process 502 permits the user 108 to query 504 the application 132 to determine information regarding the agricultural interest zone (e.g., “what pests where in the agricultural interest zone last year?”) Generally, the user 108 may query 504 the application 132 for any information relevant to the agricultural interest zone (e.g, standing in an orchard next to a tree, a user 108 may query 504 the variety of tree, moisture received by the tree over the current growing season, chemicals the tree has been treated with in the last decade, etc.; standing in a corn field, the user 108 may query 504 the variety of corn in a particular row, etc.; standing on or near a piece of equipment, the user 108 may query 504 the maintenance history of the equipment, the next scheduled maintenance, etc.; etc.). At step 506, in one embodiment, the application retrieves the requested information and transmits it, at step 508, to the user 108. In various embodiments, the application 132 may provide, at step 508, an audible response to the query 504 or a textual response. After providing the response, the lookup process 502 ends thereafter.

In a particular embodiment, the recording process 602, which may be complimentary to the data collection process as explained in connection with the description of FIG. 6, permits the user 108 to record information regarding the particular agricultural interest zone. According to a particular embodiment, the user 108 makes a note regarding the agricultural interest zone at step 604 (e.g., the presence of pests on the crops in the agricultural interest zone). In various embodiments, the application 132 may receive, at step 604, audio, visual, or textual data. At step 606, the application 132, in one embodiment, records the data regarding the agricultural interest zone. In one embodiment, the application 132, at step 608, associates the data with the location in which the data was generated. According to a particular embodiment, at step 610, the application may record additional data to bolster the data received from the user at step 604 (e.g., taking an additional sensor reading, a photo, etc.). At step 612, in one embodiment, the application 132 transmits the data from steps 604, 608, and 610 to the application server 130. In one embodiment, at step 614, the application server 130 stores the data from step 612. At step 616, in one embodiment, the application server 130 transmits confirmation of storage of the data to the application 132; at step 618, the application 132 transmits confirmation of the storage of the data to the user 108 and the recording process 602 ends thereafter.

In various embodiments, a user 108 may initiate and perform the recording process 602 on a hands-free device to collect multiple different data items in several ways. For example, in one embodiment, a user 108 may use Google Glass® to record video of the crops within a particular agricultural interest zone. In another embodiment, a user 108 may use a smartphone to record the ambient temperature of a particular agricultural interest zone. In a particular embodiment, a user 108 may use a sensor-enabled hat to record the wind speed in a particular agricultural interest zone. In yet another embodiment, a user 108 may use a tablet to record audio or typed notes regarding a particular agricultural interest zone. In a further embodiment, a user 108 may use a head-mounted device to record speech to be converted/translated to text data.

According to another particular embodiment, the recording process 602 may be used to scout crops within an agricultural interest zone. In various embodiments, crop scouting (e.g., “crop doctor procedures”) comprises uprooting plants, inspecting them for diseases, insects, and other anomalies, and recording the findings. Hands-free devices and the recording process 602, according to one embodiment, are used by the user 108 to record and share results of croup scouting. For example, in one embodiment, by using the integrated video and hands free interface of sensor-enabled eyewear, the user 108 is able to use two hands to handle crops while recording information regarding the condition of crops. Continuing with this example, the user 108 may use voice commands to perform all necessary functions such as taking photographs, requesting instructions, etc. In one embodiment, the voice commands initiates a protocol within the application 132 that triggers the hands-free device to perform a particular function (e.g., take photographs, record audio/video, record sensor data, record audio for subsequent speech to text translation, etc.) Further, in this example, data may also be broken down into specific metrics determined by crop type and results may be recorded.

Still referring to FIG. 7, additional uses of the recording process 602 for crop scouting will now be described. During the initial phase of the crop scouting, in one embodiment, a front end application (e.g., application 132) may tag each inspection with a GPS location and date, which may be received from a smart phone or other hands-free device. In one embodiment, a back end server (e.g., application service 130) may store and reduce data, and push alerts to farmers. Generally, in one embodiment, the system 100 allows the crop scouting inspection process to be automated, which decreases task difficulty and allows an unskilled person operating a hands-free device to conduct the inspection. According to one embodiment, this functionality may be enhanced by capturing a video of an uprooted plant being inspected and image processing techniques are employed by a smart phone or tablet to pull out data about the crop from the video with little or no input required from the user 108.

In one example of crop scouting, a user 108 is inspecting a cotton plant, using the agrarian data management system 100 and a hands-free device. The first step, generally, involves finding and counting the nodes between the root structure and the first flowering branch. As will be appreciated by one having ordinary skill in the art, while node counting is one part of one task for inspecting one type of plant, the techniques used in the following example may be modified and tuned to work for a variety of different objectives. In one embodiment, the process for finding the number of visible cotton nodes in a single frame from a video employs techniques of image analysis. Generally, in various embodiments, the system 100 may analyze multiple frames to track and confirm critical points and help reduce false positive noise. In various embodiments, the steps in node detection may be performed by the processor 140 from FIG. 5.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed inventions may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed invention are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), a personal area network (PAN), virtual networks (WAN, LAN, or PAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

What is claimed is:

1. A method, comprising the steps of:
retrieving one or more predefined criteria corresponding to data management associated with a particular agricultural interest zone;
transmitting the retrieved one or more predefined criteria for the particular agricultural interest zone to a particular hands-free device being operated by a user in the particular agricultural interest zone;
receiving one or more data items from the particular hands-free device, wherein the one or more data items were automatically collected at the particular agricultural interest zone by the particular hands-free device;
normalizing the one or more data items into a predetermined standardized format;
comparing the normalized one or more data items to the retrieved one or more predefined criteria to ensure compliance with the retrieved one or more predefined criteria; and
upon determination of compliance with the retrieved one or more predefined criteria, associating the normalized one or more data items with the particular agricultural interest zone and storing the normalized one or more data items in a database for subsequent processing.

2. The method of claim 1, wherein normalizing the one or more data items into a predetermined standardized format further comprises the steps of:
identifying a received format of a particular data item;
retrieving the predetermined standardized format for a particular data item type corresponding to the particular data item from the retrieved one or more predefined criteria; and
converting the particular data item from the received format to the predetermined standardized format.

3. The method of claim 1, wherein comparing the normalized one or more data items to the retrieved one or more predefined criteria to ensure compliance with the retrieved one or more predefined criteria further comprises the steps of:
identifying an expected range of a particular normalized data items from the retrieved one or more predefined criteria; and
confirming that the particular normalized data item is within the expected range.

4. The method of claim 1, wherein comparing the normalized one or more data items to the retrieved one or more predefined criteria to ensure compliance with the retrieved one or more predefined criteria further comprises the steps of:
identifying an expected range of a particular normalized data items from the retrieved one or more predefined criteria;
confirming that the particular normalized data item is within the expected range; and
upon determination that the particular normalized data item is not within the expected range,
transmitting a request for re-collection of the particular normalized data item to the particular hands-free device;
receiving a recollected data item from the particular hands-free device;
normalizing the recollected data item into the predetermined standardized format for the particular data item; and
determining whether the normalized recollected data item is within the expected range.

5. The method of claim 1, wherein the particular hands-free device is selected from the group comprising a mobile phone, a tablet, a head-mounted device, a sensor-enabled eyewear, a sensor-enabled hat, or a sensor-enabled piece of farm equipment.

6. The method of claim 5, wherein the piece of farm equipment is selected from the group comprising a tractor, a planter, a combine, a chemical application sprayer, or a baler.

7. The method of claim 1, wherein the predefined criteria includes a request to gather one or more atmospheric data items.

8. The method of claim 7, wherein the one or more atmospheric data items is selected from the group comprising ambient temperature, barometric pressure, humidity, and light exposure.

9. The method of claim 1, wherein the predefined criteria includes a request to gather one or more geographic data items.

10. The method of claim 1, wherein the predefined criteria includes a request to gather one or more temporal data items.

11. The method of claim 1, wherein the predefined criteria includes a request to gather one or more data items regarding one or more crops within the particular agricultural interest zone.

12. The method of claim 1, wherein the predefined criteria includes a request to gather one or more data items regarding the particular agricultural interest zone.

13. The method of claim 1, wherein the hands-free device comprises a device that receives voice data from the user in a hands-free manner and is configured to convert the voice data to text data.

14. The method of claim 1, wherein the hands-free device comprises a device that receives voice data from the user in a hands-free manner and is configured to respond to voice commands.

15. A method, comprising the steps of:
receiving a location identifier, corresponding to a particular physical location, from a particular hands-free device;
determining whether the particular physical location is within one or more predefined geofences, corresponding to one or more agricultural interest zones; and
upon determination that the particular physical location is within one or more predefined geofences,
retrieving one or more predefined criteria corresponding to data management associated with the one or more predefined geofences; and
transmitting the retrieved one or more predefined criteria for the one or more predefined geofences to the particular hands-free device for subsequent data management purposes.

16. The method of claim 15, further comprising the steps of:
receiving one or more data items from the particular hands-free device, wherein the one or more data items were automatically collected at the particular physical location by the particular hands-free device;
normalizing the one or more data items into a predetermined standardized format;
comparing the normalized one or more data items to the retrieved one or more predefined criteria to ensure compliance with the retrieved one or more predefined criteria; and
upon determination of compliance with the retrieved one or more predefined criteria, associating the normalized one or more data items with the one or more predefined geofences and storing the normalized one or more data items in a database for subsequent processing.

17. The method of claim 16, wherein normalizing the one or more data items into a predetermined standardized format further comprises the steps of:
identifying a received format of a particular data item;
retrieving the predetermined standardized format for a particular data item type corresponding to the particular data item from the retrieved one or more predefined criteria; and
converting the particular data item from the received format to the predetermined standardized format.

18. The method of claim 16, wherein comparing the normalized one or more data items to the retrieved one or more predefined criteria to ensure compliance with the retrieved one or more predefined criteria further comprises the steps of:
identifying an expected range of a particular normalized data items from the retrieved one or more predefined criteria; and
confirming that the particular normalized data item is within the expected range.

19. The method of claim 16, wherein comparing the normalized one or more data items to the retrieved one or more predefined criteria to ensure compliance with the retrieved one or more predefined criteria further comprises the steps of:
identifying an expected range of a particular normalized data items from the retrieved one or more predefined criteria;
confirming that the particular normalized data item is within the expected range; and
upon determination that the particular normalized data items is not within the expected range,
transmitting a request for re-collection of the particular normalized data item to the particular hands-free device;
receiving a recollected data item from the particular hands-free device;
normalizing the recollected data item into the predetermined standardized format for the particular data item; and
determining whether the normalized recollected data item is within the expected range.

20. The method of claim 19, wherein the stored data items are associated with at least a first geofence and the subsequent processing further comprises the step of comparing all of the stored data items for the first geofence with each other to determine any trends occurring within the first geofence.

21. The method of claim 20, wherein the stored data items are further associated with at least a second geofence and the subsequent processing further comprises the step of comparing all of the stored data items for the first geofence with all of the stored data items for the second geofence to determine any trends occurring within the first or second geofences and/or any trends occurring across the first and second geofences.

22. A method, comprising the steps of:
determining a particular location identifier, corresponding to the particular physical location of a hands-free device;
transmitting the particular location identifier to a server;
receiving one or more predefined criteria, corresponding to data management associated with the particular location identifier, from the server;
determining, from the received on or more predefined criteria, one or more data items to collect from the particular physical location and the manner of collection for each of the one or more data items;
collecting the determined one or more data items from the particular physical location through the determined manner of collection; and
transmitting the collected one or more data items to the server for subsequent processing.
